(19) United States
(12) Patent Application Publication
(10) Pub. No.: US 2008/0149417 A1
(43) Pub. Date: Jun. 26, 2008

(54) Acoustic assembly for personal media device

(75) Inventors: Richard Hung Minh Dinh, San Jose, CA (US); Tang Yew Tan, San Francisco, CA (US); Derek Boyd Barrentine, San Jose, CA (US); Michael M. Lee, San Jose, CA (US)

Correspondence Address: ROPES & GRAY LLP, PATENT DOCKETING 39/41, ONE INTERNATIONAL PLACE, BOSTON, MA, 02110-2624, US

(73) Assignee: Apple Computer, Inc.

(21) Appl. No.: 11/643,544

(22) Filed: Dec. 21, 2006

(51) Int. Cl. H04R 7/00

(52) U.S. Cl. 181/145

(57) ABSTRACT

Systems and methods are provided for media devices including an acoustic source that emits a sound, a first chamber that receives the sound and couples a first portion of the sound outside of the media device, and a second chamber that receives a second portion of the sound from the first chamber.

### BACKGROUND

This invention relates to personal media devices and, more particularly, to acoustic assemblies for personal media devices.

The proliferation of compact portable personal media devices (e.g., portable MP3 players, portable video players, and media capable cellular telephones) has created a need for improved delivery of audio (e.g., voice and music) to users while respecting the need to minimize the overall form factor of personal media devices.

One problem with existing media devices such as cellular telephones is that the sensitivity of the media device's acoustic source, e.g., speaker, can be adversely effected by a user. For example, when a user presses their ear against the housing of a cellular telephone where the housing aperture of the speaker is located, the user's ear can form a seal that alters the sensitivity of the acoustic source. This effect may be the result of increased pressure applied to the acoustic source or the result of directly coupling the user's eardrum with the acoustic source. Existing media devices attempt to mitigate this problem by adjusting the dimensions of the housing aperture or including an additional housing aperture such that a seal with the user's ear is prevented. Because the shape and size of each user's ears can vary, this approach is not comprehensive enough to cover all potential users. Accordingly, there is a need for a more comprehensive approach to improving acoustic source audio quality for any potential user.

Another problem with existing media devices is that the acoustic source must typically be positioned adjacent to the housing aperture to maximize the acoustic coupling from the acoustic source to a user's ear. Because personal media devices require compact form factors, the need to position the acoustic source adjacent to the housing aperture limits the manufacturer's ability to configure or arrange certain internal circuit components within the personal media device. Accordingly, there is a need for efficiently coupling audio from an acoustic source to the housing aperture without requiring the acoustic source to be directly adjacent to the housing aperture.

Another problem with existing media devices is that the acoustic source may not be properly tuned for providing certain audio such as voice, music, or both. Accordingly, there is a need for more appropriately tuning the audio output of media devices such as cellular telephones to further improve acoustic source audio quality.

### SUMMARY

The invention, in various embodiments, addresses deficiencies in the prior art by providing systems, methods and devices that enhance sound quality and design flexibility of media devices while respecting the need for a compact and portable form factor for such devices.

In various aspects, the invention employs an acoustic assembly in a media device. The acoustic assembly includes an acoustic source that emits a sound into a first chamber. The first chamber then couples a first portion of the sound outside of the media device to a listening user. The first chamber also couples a second portion of the sound into a second chamber such as the inside cavity of the media device. The coupling of sound from the first chamber to the user and to the second chamber may be via apertures that enable the flow of sound waves from the first chamber. By adjusting the volume or size of the first chamber in relation to the volume or size of the second chamber, the sensitivity or frequency response of acoustic assembly is adjusted to enhance the quality of the sound received by the listening user. Also, by adjusting the size or area of the apertures, the sensitivity or frequency response of acoustic assembly is adjusted to enhance the quality of the sound received by the listening user. Further, the aggregate size of numerous opening or gaps in the shell or housing of the media device may be determined to define an effective leak aperture size for the second chamber which can then be used to optimize the size of the apertures and first chamber to enhance the frequency response of the acoustic assembly.

Various advantages and applications using an acoustic assembly for enhanced acoustic coupling from a media device to a user in accordance with principles of the present invention are discussed in more detail below.

### BRIEF DESCRIPTION OF THE DRAWINGS

The above and other features of the present invention, its nature and various advantages will become more apparent upon consideration of the following detailed description, taken in conjunction with the accompanying drawings, in which like reference characters refer to like parts throughout, and in which:

FIG. 1 is a perspective view of a media device according to an illustrative embodiment of the invention;

FIG. 2 shows the media device of FIG. 1 with tethered headphones and, alternatively, a wireless earpiece according to an illustrative embodiment of the invention;

FIG. 3 shows a simplified functional block diagram of a media device according to an illustrative embodiment of the invention;

FIG. 4 shows a cross-sectional view of an acoustic assembly according to an illustrative embodiment of the invention;

FIG. 5 shows a cross-sectional view of an acoustic assembly where the output aperture location is shifted with respect to the acoustic source according to an illustrative embodiment of the invention;

FIG. 6 is a flowchart showing the process for providing sound from an acoustic assembly to the user of a media device according to an illustrative embodiment of the invention;

FIG. 7 shows a graph of sensitivity versus frequency for an acoustic assembly according to an illustrative embodiment of the invention;

FIG. 8 shows a cross-sectional view of another acoustic assembly according to an illustrative embodiment of the invention;

FIG. 9 shows a cross-sectional view of an acoustic assembly including acoustically permeable materials at one or more apertures according to an illustrative embodiment of the invention; and

FIG. 10 shows a perspective multilayered view of an acoustic assembly within a portion of a media device according to an illustrative embodiment of the invention.

### DETAILED DESCRIPTION OF THE DISCLOSURE

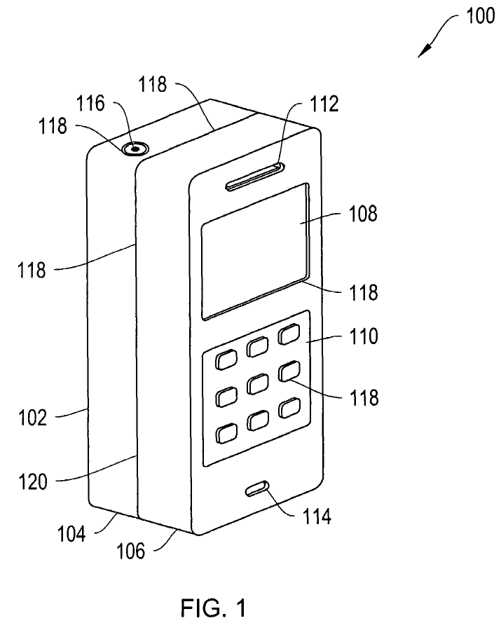

FIG. 1 is a perspective view of a media device 100 according to an illustrative embodiment of the invention. The media device 100 includes a housing 102, a first housing portion 104, a second housing portion 106, a display 108, a keypad 110, a speaker housing aperture 112, a microphone housing aperture 114, and a headphone jack 116. The housing 102 also includes various gaps 118 that may include openings, separations, vents, or other pathways between elements of the housing 102 that enable the passage of air or sound through the housing 102.

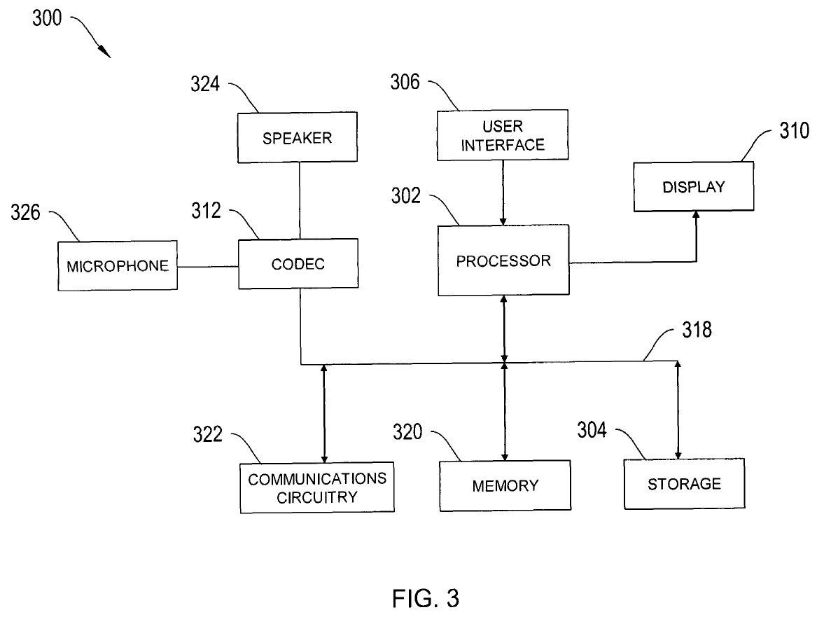

In one embodiment, the housing 102 includes a first housing portion 104 and a second housing portion 106 that are fastened together to encase various components of the media device 100. The housing 102 and its housing portions 104 and 106 may include polymer-based materials that are formed by, for example, injection molding to define the form factor of the media device 100. In one embodiment, the housing 102 surrounds and/or supports internal components such as, for example, one or more circuit boards having integrated circuit components, internal radio frequency (RF) circuitry, an internal antenna, a speaker, a microphone, a hard drive, a processor, and other components. Further details regarding certain internal components are discussed later with respect to FIG. 3. The housing 102 provides for mounting of a display 108, keypad 110, external jack 116, data connectors, or other external interface elements. The housing 102 may include one or more housing apertures 112 to facilitate delivery of sound, including voice and music, to a user from a speaker within the housing 102. The housing 102 may including one or more housing apertures 114 to facilitate the reception of sounds, such as voice, for an internal microphone from a media device user.

In certain embodiments, the housing 102 includes one or more gaps 118 associated with the housing 102. These gaps 118 may result from the manufacturing and/or assembly process for the media device 100. For example, in certain circumstances, the mechanical attachment of the first housing portion 104 with the second housing portion 106 results in a crease 120 or joint between the portions 104 and 106. In certain media devices 100, the crease 120 is not air tight, resulting in gaps 118 along the crease. Other gaps may be formed during assembly between, for example, one or more keys of the keypad 110 and the housing 102 or the display 108 and the housing 102, resulting in additional gaps 118. In other embodiments, the housing 102 may include addition portions that are integrated to form the housing 102 for the media device 100.

The media device 100 may include a wireless communications device such as a cellular telephone, satellite telephone, cordless telephone, personal digital assistant (PDA), pager, portable computer, or any other device capable of wireless communications. In fact, FIG. 1 shows an exemplary cellular telephone version of a broad category of media device 100.

The media device 100 may also be integrated within the packaging of other devices or structures such a vehicle, video game system, appliance, clothing, helmet, glasses, wearable apparel, stereo system, entertainment system, or other portable devices. In certain embodiments, device 100 may be docked or connected to a wireless enabling accessory system (e.g., a wi-fi docking system) that provides the media device 100 with short-range communicating functionality. Alternative types of media devices 100 may include, for example, a media player such as an ipod available by Apple Computer Inc., of Cupertino, Calif., pocket-sized personal computers such as an iPAQ Pocket PC available by Hewlett Packard Inc., of Palo Alto, Calif. and any other device capable of communicating wirelessly (with or without the aid of a wireless enabling accessory system).

In certain embodiments, the media device 100 may synchronize with, for example, a remote computing system or server to receive media (using either wireless or wireline communications paths). Wireless syncing enables the media device 100 to transmit and receive media and data without requiring a wired connection. Media may include, without limitation, sound or audio files, music, video, multi-media, and digital data, in streaming and/or discrete (e.g., files and packets) formats.

During synchronization, a host system may provide media to a client system or software application embedded within the media device 100. In certain embodiments, media and/or data is “downloaded” to the media device 100. In other embodiments, the media device 100 is capable of uploading media to a remote host or other client system. Further details regarding the capabilities of certain embodiments of the media device 100 are provided in U.S. patent application Ser. No. 10/423,490, filed on Apr. 25, 2003, the entire contents of which are incorporated herein by reference.

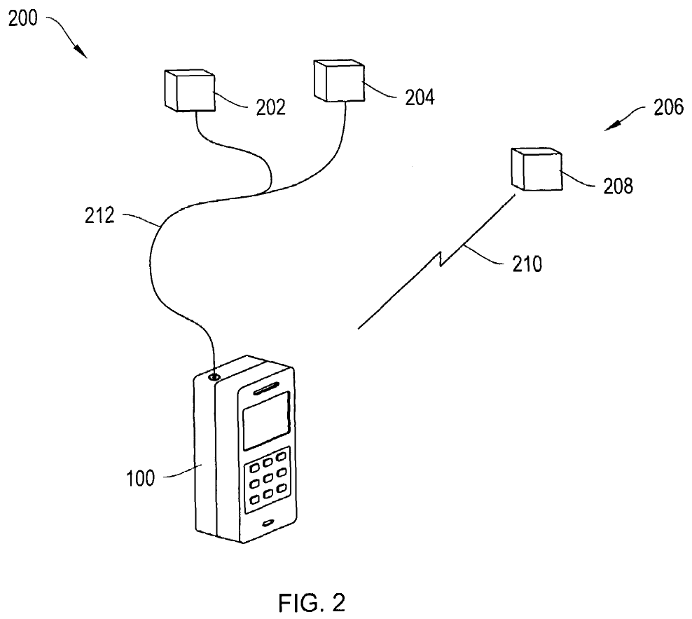

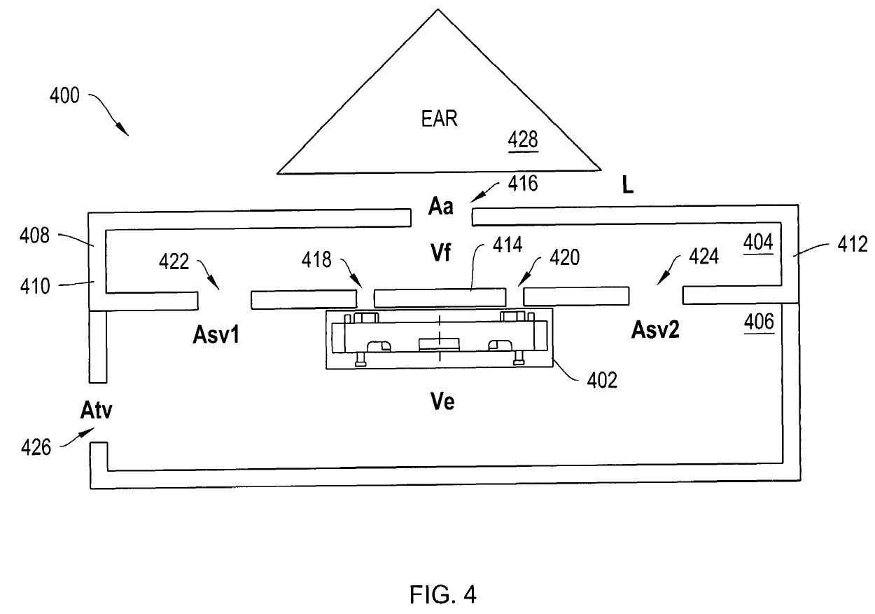

FIG. 2 shows the media device 100 of FIG. 1 with tethered headphones 200 and, alternatively, a wireless earpiece 206 according to an illustrative embodiment of the invention. The tethered headphones 200 include a cable 212 that connects to the media device 100 via external jack 116. In one embodiment, the cable provides for transport of an audio signal from the media device 100 to the headphones 100. In another embodiment, the headphones 200 includes a left housing 202 and a right housing 204, corresponding to the left and right ears of a user, respectively. Each housing 202 and 204 may include a speaker and/or an acoustic assembly as described later with respect to FIG. 4. The headphones 200 may optionally include a microphone to facilitate sending sounds from the user to the media device 100. As an alternative to the headphones 200, a user may utilize the wireless earpiece 206 which includes a housing 208. In one embodiment, the earpiece 206 employs wireless channel 210 to receive audio signals from the device 100 or transmit audio signals to the device 100. The housing 208 may include a speaker, microphone, and/or acoustic assembly as described later with respect to FIG. 4.

FIG. 3 shows a simplified functional block diagram of the media device 100 according to an illustrative embodiment of the invention. The media device or player 300 may include a processor 302, storage device 304, user interface 308, display 310, CODEC 312, bus 318, memory 320, communications circuitry 322, a speaker or transducer 324, and a microphone 326. Processor 302 may control the operation of many functions and other circuitry included in media player 300. Processor 302 may drive display 310 and may receive user inputs from user interface 308.

Storage device 304 may store media (e.g., music and video files), software (e.g., for implanting functions on device 300, preference information (e.g., media playback preferences), lifestyle information (e.g., food preferences), exercise information (e.g., information obtained by exercise monitoring equipment), transaction information (e.g., information such as credit card information), wireless connection information (e.g., information that may enable media device to establish wireless communication with another device), subscription information (e.g., information that keeps tracks of podcasts or television shows or other media a user subscribes to), and any other suitable data. Storage device 304 may include one more storage mediums, including for example, a hard-drive, permanent memory such as ROM, semi-permanent memory such as RAM, or cache.

Memory 320 may include one or more different types of memory which may be used for performing device functions. For example, memory 320 may include cache, ROM, and/or RAM. Bus 318 may provide a data transfer path for transferring data to, from, or between at least storage device 304, memory 320, and processor 302. Coder/decoder (CODEC) 112 may be included to convert digital audio signals into an analog signal for driving the speaker 324 to produce sound including voice, music, and other like audio. The CODEC 112 may also convert audio inputs from the microphone 326 into digital audio signals.

User interface 308 may allow a user to interact with the media device 300. For example, the user input device 308 can take a variety of forms, such as a button, keypad, dial, a click wheel, or a touch screen. Communications circuitry 322 may include circuitry for wireless communication (e.g., short-range and/or long range communication). For example, the wireless communication circuitry may be wi-fi enabling circuitry that permits wireless communication according to one of the 802.11 standards. Other wireless network protocols standards could also be used, either in alternative to the identified protocols or in addition to the identified protocol. Other network standards may include Bluetooth, the Global System for Mobile Communications (GSM), and code divisional multiple access (CDMA) based wireless protocols. Communications circuitry 322 may also include circuitry that enables device 300 to be electrically coupled to another device (e.g., a computer or an accessory device) and communicate with that other device.

In one embodiment, the media device 300 may be a portable computing device dedicated to processing media such as audio and video. For example, media device 300 may be a media player (e.g., MP3 player), a game player, a remote controller, a portable communication device, a remote ordering interface, an audio tour player, or other suitable personal device. The media device 300 may be battery-operated and highly portable so as to allow a user to listen to music, play games or video, record video or take pictures, communicate with others, and/or control other devices. In addition, the media device 300 may be sized such that is fits relatively easily into a pocket or hand of the user. By being handheld, the media device 300 (or media device 100 shown in FIG. 1) is relatively small and easily handled and utilized by its user and thus may be taken practically anywhere the user travels.

As discussed previously, the relatively small form factor of certain prior art media devices has constrained the ability of these media devices to provide or receive sound and/or audio having an adequate sensitivity or range of sensitivity. Conversely, the need to provide sound for a user having an adequate quality in prior art devices has often required the device speaker or acoustic source to be in close proximity or adjacent to its housing aperture. This requirement has limited the configuration and/or arrangement of internal components within prior art media devices. Accordingly, embodiments of the invention provide for improved sound quality along with flexible arrangement and/or positioning of a speaker, acoustic source, and/or acoustic assembly and other components within a media device 100.

FIG. 4 shows a cross-sectional view of an acoustic assembly 400 according to an illustrative embodiment of the invention. The acoustic assembly 400 includes an acoustic source 402, a first chamber 404, a second chamber 406, a housing 408, a first lateral wall 410, a second lateral wall 412, a retaining wall 414, an output aperture 416, a first source aperture 418, a second source aperture 420, a first transfer aperture 422, a second transfer aperture 424, and a leak aperture 426. A user's ear 428 is typically positioned in proximity to the output aperture 416 to enable the user to receive sound, e.g., voice or music, from the aperture 416. The acoustic source 402 may be micro-speaker such as a speaker in 2403 Receiver family manufactured by NXP Semiconductors of Eindhoven, The Netherlands.

In certain embodiments, the acoustic assembly 400 is included within, for example, the housing 102 of the media device 100 as shown in FIG. 1. In one embodiment, the housing 408 corresponds to the housing 102 of FIG. 1. Thus, the first chamber 404 may be a cavity, void, space, or enclosure within the housing 102. Also, the second chamber may be a second cavity, void, space, or enclosure within the housing 102. In certain embodiments, the acoustic source 402 emits sound through at least one aperture such as apertures 418 and 420 into the first chamber 404. In one embodiment, the second chamber 406 is in contact with or directly coupled to the acoustic source 402. Either chamber 404 or 406 may be filled with air, a gas mixture other than air, a liquid, or other acoustically permeable material. The acoustic source may include a transducer, a speaker, or a micro-speaker. The acoustic source may be referred to as an acoustic receiver which is distinct from an RF receiver.

In one embodiment, the size or area of the leak aperture 426 is derived from plurality of actual apertures or gaps 118 in the housing 102 (as shown in FIG. 1). In certain embodiments, the effective area of the leak aperture 426 is calculated, measured, and/or algorithmically modeled from an aggregation of the gaps 118 to estimate the effective leak rate of sound from the second chamber 406. In one embodiment, the second. chamber 406 includes a cavity within the housing 408 (or housing 102 of FIG. 1) other than the volume of the chamber 404. Thus, the effective area of the aperture 426 may include the sum of the areas of all of the gaps 118 of the housing 102. Because, in certain embodiments, the media device 100 is manufactured and/or assembled using a repeatable and/or predictable process with consistent component dimensions, the effective area and/or leak rate of the aperture 426 can be predicted and/or estimated within a reasonable tolerance for every media device 100. Thus, for example, the volume of the first chamber 404 or the area of the apertures other than the effective aperture 426 may be configured to optimize the tuning of the sound emitted from the aperture 416 for a large volume of media devices 100.

In another embodiment, the acoustic source 402 is disposed in a position that overlaps or is adjacent to only a portion of the output aperture 416. To direct sound or sound waves from the acoustic source 402 to the aperture 416, the acoustic source 402 employs the first chamber 404, i.e., a front cavity, which is defined by the lateral walls 410 and 412 and the retaining wall 414 that extends between the lateral walls 410 and 412. The retaining wall may include at least one transfer aperture such as apertures 422 and 424 that permit sound waves to flow from the first chamber 404 to the second chamber 406. The transfer apertures 422 and 424 may be considered leak apertures from the first chamber 404. In one embodiment, the second chamber 406 includes the internal volume of the media device 100 other than the volume of the first chamber 404. To provide an outlet for sound waves that have leaked into the chamber 406, a plurality of apertures (represented conceptually as leak aperture 426) may be disposed throughout the housing of the media device (e.g., gaps 118). Alternatively, one or more gaps 118 may be selectively machined through the housing 408 to adjust the effective leak aperture 426 size.

In one embodiment, the retaining wall 414 provides a surface to which the acoustic source 402 is affixed. The retaining wall may include apertures such as source apertures 418 and 420 that permit the flow of sound waves from the acoustic source 402 into the first chamber 404. In certain embodiments, the transfer or internal leak apertures 422 and 424 permit improved control of the acoustic quality of the sound emitted from the aperture 416.

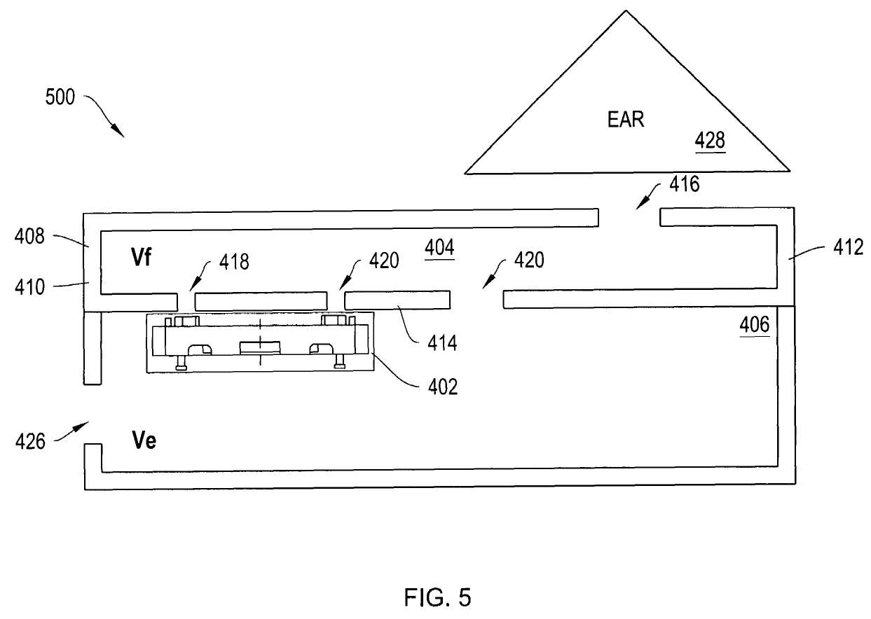

FIG. 5 shows a cross-sectional view of an acoustic assembly 500 where the location of the output aperture 416 location is shifted in relation to the acoustic source 402 according to an illustrative embodiment of the invention. By incorporating a first chamber 404 between the acoustic source 402 and the output aperture 416, the acoustic source 402 can be advantageously disposed at any location in the housing 408 with respect to the output aperture 416.

Accordingly, FIG. 5 illustrates that the position of the output aperture 416 and, therefore, a user's ear 428 may be shifted in relation to the acoustic source 402. Thus, the position of the acoustic source 402, the output aperture 416, and the resulting position of the user's ear 428 may be adjusted.

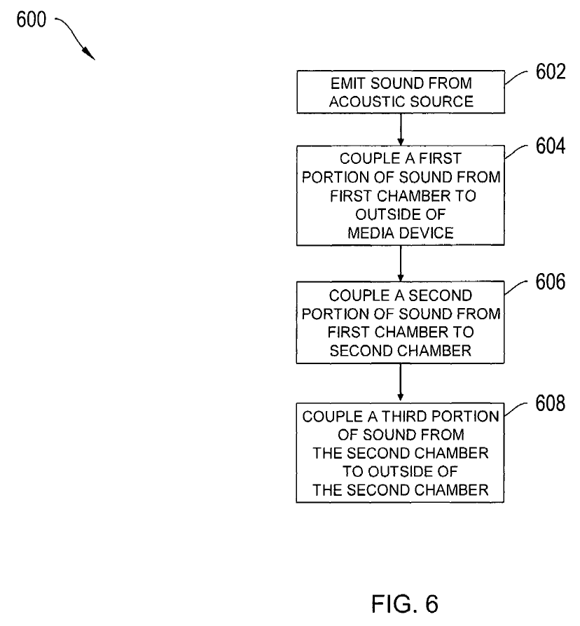

FIG. 6 is a flowchart showing the process for providing sound from the acoustic assembly 400 to the user of a media device 100 according to an illustrative embodiment of the invention. In one embodiment, the acoustic source 402 emits sound into the first chamber 404 associated with the media device 100 (Step 602). Then, a first portion of the sound is coupled from the first chamber 404 to outside of the media device 100 via at least the output aperture 416 (Step 604). Further, a second portion of the sound is coupled from the first chamber 404 to the second chamber 406 via at least the transfer aperture 420 (Step 606). Then, a third portion of the sound is coupled from the second chamber 406 to outside of the second chamber 406 via at least one leak aperture 426 (Step 608). In certain embodiments, the second chamber is the internal cavity of a media device 100 and the third portion of the sound is coupled outside of the media device 100 via a plurality of apertures or gaps 118.

It is understood the steps shown in FIG. 6 are merely illustrative and that additional steps may be added and that existing steps may be altered or omitted.

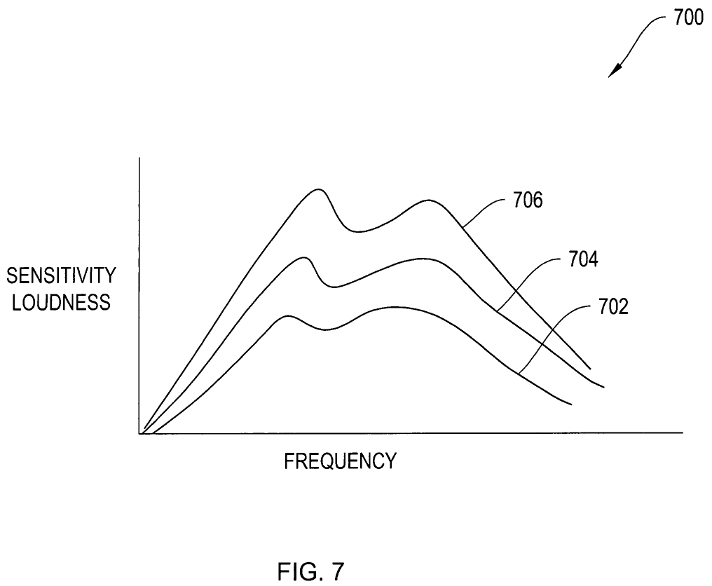

FIG. 7 shows a graph 700 of sensitivity or loudness versus frequency for an acoustic assembly such as acoustic assembly 400 according to an illustrative embodiment of the invention. In certain embodiments, the volume of the second chamber 406 is the cavity of the media device which is determined by other design constraints such a component arrangement, device shape, and aesthetic considerations. Thus, the volume of the second chamber 406 is fixed by other constraints of the manufacturing and design process. In this circumstance, the volume of the first chamber 404 is adjusted and/or configured in relation to the volume of the second chamber 406 to adjust the sensitivity and/or frequency response of the acoustic assembly 400 as shown in FIG. 7.

FIG. 7 further illustrates that the frequency response of the acoustic assembly 400, in certain embodiments, is modified by adjusting the volume of the first chamber 404 to various volumes 702, 704, and 706 in relation to the volume of the second chamber 406. Accordingly, in certain embodiments, the volume of the first chamber 404 is adjusted, defined, and/or configured in relation to the volume of the second chamber 406 to tune the first portion of the sound. Tuning may include modifying frequency responsiveness of the acoustic assembly which may further include modifying the sensitivity or loudness of the sound with respect to frequency over a range of frequencies.

Along with adjusting the volumes of chambers 404 and 406, the sound quality may be modified by adjusting the aperture sizes and/or areas associated with the acoustic assembly 400. Accordingly, in certain embodiments, any one or more of the area of the first aperture, the area of the second aperture, the volume of the first chamber, and the volume of the second chamber may be adjusted, configured, and/or defined in relation to each other to tune the first portion of the sound.

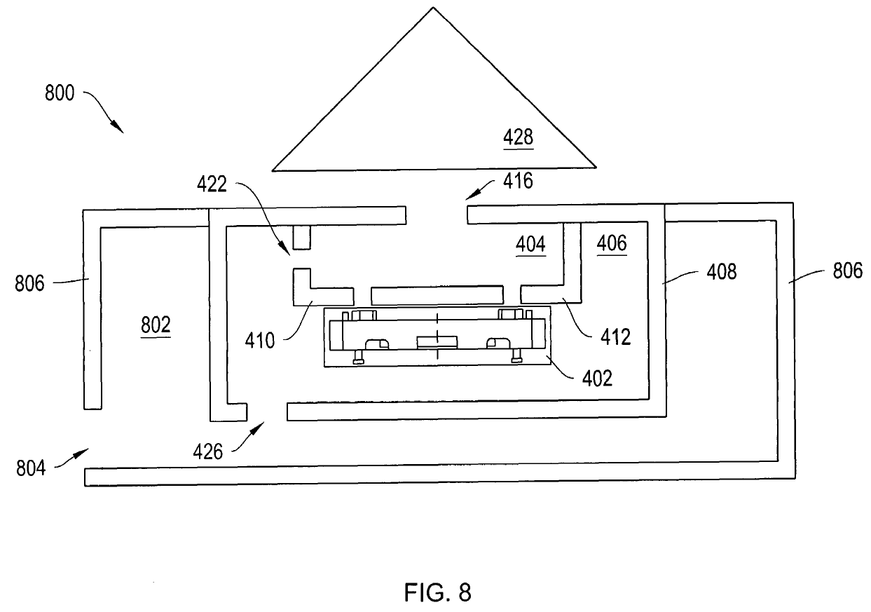

FIG. 8 shows a cross-sectional view of an another acoustic assembly 800 according to an illustrative embodiment of the invention. In this alternative embodiment, the third portion of the sound from the second chamber 406 is coupled to a third chamber 802 associated with the media device 100 via aperture 426. In one embodiment, the third chamber 802 includes a plurality of apertures 804 or gaps 118 for coupling a forth portion of the sound outside of the media device 100. In certain embodiments, the housing 806 is the outer housing of a media device 100 and corresponds the housing 102 of FIG. 1. In one embodiment, the size of the aperture 426 may be selectively configured to enable tuning of the sound from output aperture 416 while controlling the relative volumes of chambers 404 and 406. In certain embodiments, any one or more of the area of the aperture 416, the area of the aperture 422, the area of the aperture 426, the volume of the chamber 404, and the volume of the chamber 406 may be adjusted, configured, and/or defined in relation to each other to tune the first portion of the sound emitted from the output aperture 416.

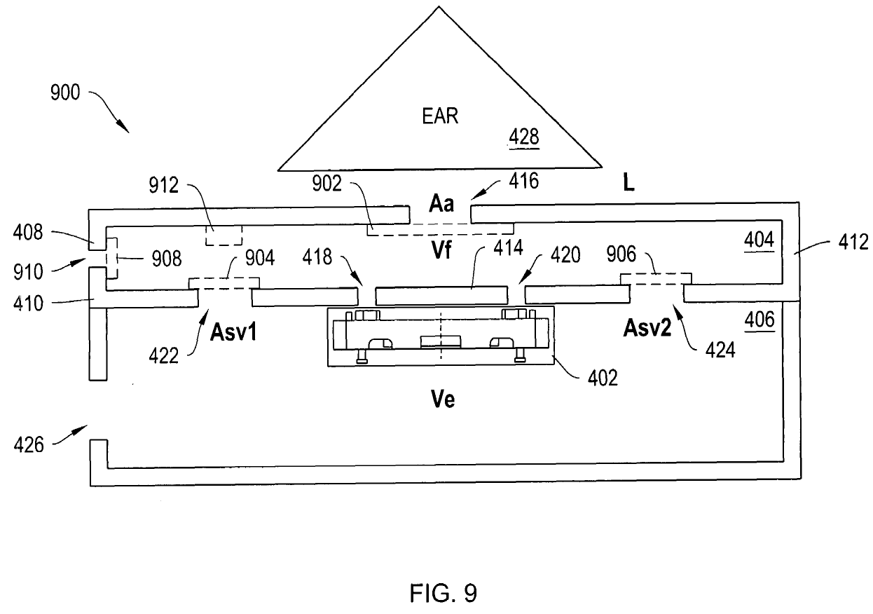

FIG. 9 shows a cross-sectional view of an acoustic assembly 900 including acoustically permeable seals 902, 904, 906, and 908 at one or more apertures 416, 422, 424, and 910 according to an illustrative embodiment of the invention. The acoustically permeable seals 902, 904, 906, and 908 may optionally be positioned at each aperture 416, 422, 424, and 910 respectively to optimize the size of each aperture or to adjust the frequency response of the acoustic assembly 910. Each seal may be positioned on the outside or inside of each aperture. Acoustic seals 902, 904, 906, and 908 are shown for illustrative purposes and, therefore, only one, a portion, or all of seals may be employed by the acoustic assembly 900. An acoustic seal may also be referred to as an acoustic resister capable of slowing down and/or reducing sound flow or flow pressure. In one embodiment, the acoustic seal includes cloth, a polymer-based fabric, or a mesh of fabric.

In certain embodiments, an acoustic seal 902 is attached to the aperture 416 to optimize the size of the aperture 416. In one embodiment, by increasing the density of the material or medium used for the seal 902, the size of the aperture 416 can be increased which reduces the need a smaller aperture. Less stringent aperture dimensions may reduce the need for more precise aperture machining. In certain embodiments, the size of an aperture may be less than or equal to about 0.1 mm, 0.25 mm, 0.5 mm, 1 mm, 3 mm, 5 mm, 6 mm, 8 mm, 10 mm, 12 mm, or 15 mm. Also, the shape or design of the aperture 416 or other apertures may be configured for aesthetic reasons while maintaining a desired sound flow. In another embodiment, one or more of the seal 902, at least one of the seals 904 and 906, the area of the output aperture 416, the area of the at least one of the transfer apertures 422 and 424, the volume of the first chamber 404, and the volume of the second chamber 406 are adjusted, configured, and/or defined in relation to each other to tune the sound emitted from the aperture 416 of the acoustic assembly 900.

In certain embodiments, the present invention includes one or more sensors 912 disposed within the first chamber 404 or a front cavity of the acoustic assembly 900. Sensors, such as sensor 912, may interact with the external environment and include, without limitation, an ambient light emitter, an ambient light sensor, and/or a proximity sensor. Rather than provide additional apertures or gaps 118 through the skin of the housing 102 of the media device 100, these sensors 912 can use the acoustic aperture 416 to interact with the environment surrounding or within a certain proximity of the media device 100. By reducing the number of apertures in the housing 102 of the media device 100, the face of the device 100 may be manufactured using fewer steps and/or operations, and provide greater aesthetic appeal.

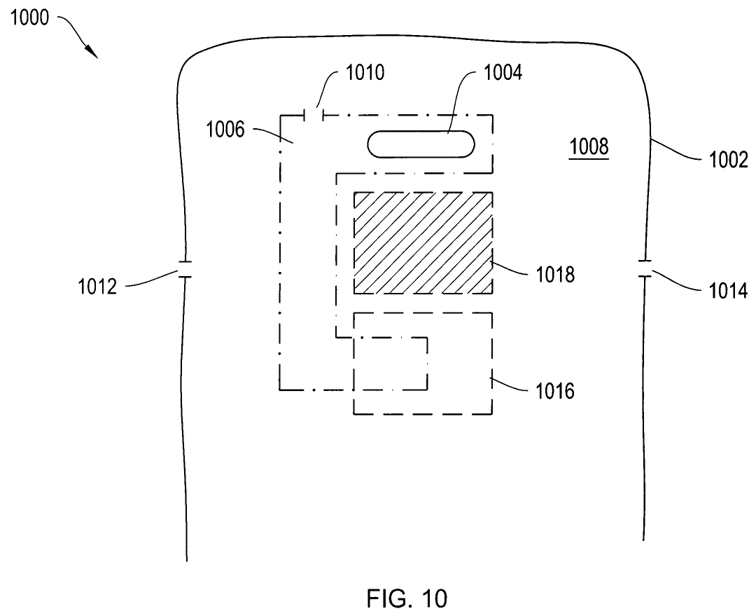

FIG. 10 shows a perspective multilayered view of an acoustic assembly 1000 within a portion of a media device 100 according to an illustrative embodiment of the invention. The acoustic assembly includes a media device housing 1002, an output aperture 1004, a first chamber 1006, a second chamber 1008, a transfer aperture 1010, leak apertures 1012 and 1014, an acoustic source 1016, and a circuit component 1018.

In operation, the acoustic assembly 1000 operates a similar manner as described in FIG. 5 and with respect to the acoustic assembly 400 of FIG. 4. FIG. 10 shows a top-down view of the various components of the acoustic assembly 1000 to illustrate that the dimensions, orientation, location, and shape of various the components may vary depending on the position of other components such as circuit component 1018. In one embodiment, the first chamber 1006 is shaped in a form that accommodates the position of the circuit component 1018 while enabling the sound from the acoustic source 1016 to be emitted from the output aperture 1004. The shape and size of the first chamber 1006 may vary according to the available space and position of components within the housing 1002. The shape of the chamber 1006 may be elongated, spherical, rectangular, circular, radial, spiral, stepped, conical, cylindrical, or any shape, geometry, or combination of shapes.

In certain embodiments, first, second, third, or any other chambers of a media device 100 may include substantially air. In other embodiments, at least one of the first, second, third, or other chambers may include at least one of a gas other than air, a gas mixture other than air, or acoustically conductive matter. The acoustically conductive material may include a solid, liquid, gel, or like material capable of conducting sound and/or sound waves.

In one embodiment, the first and second chambers 404 and 406 of FIG. 4 are included within a peripheral element such as a headphone, wireless headphone, or like ear-coupling housing. For example, a peripheral element, such as housings 202, 204, or 208 of the media device 100 as shown in FIG. 2, may include an acoustic assembly 400 as shown in FIG. 4.

In certain embodiments, an acoustic assembly may be employed with a audio receiver such as the microphone 326 of FIG. 3 to enhance the quality of sound received by a media device 100. Thus, with respect to FIG. 4, the acoustic source 402 may optionally represent a microphone 326 while the aperture 416 may optionally represent the microphone housing aperture 118 of FIG. 1.

It is understood that the various features, elements, or processes of the foregoing figures and description are interchangeable or combinable to realize or practice the invention describe herein. Those skilled in the art will appreciate that the invention can be practiced by other than the described embodiments, which are presented for purposes of illustration rather than of limitation, and the invention is limited only by the claims which follow.

What is claimed is:

1. a method for delivering sound from a media: device comprising:
emitting sound from an acoustic source into a first chamber associated with the media device,
coupling a first portion of the sound from the first chamber to outside of the media device, and
coupling a second portion of the sound from the first chamber to a second chamber associated the media device.

2. The method of claim 1, wherein coupling the first portion of the sound from the first chamber to outside of the media device is via at least a first aperture.

3. The method of claim 2, wherein coupling the second portion of the sound from the first chamber to the second chamber is via at least a second aperture.

4. The method of claim 3 comprising coupling a third portion of the sound from the second chamber to outside of the second chamber.

5. The method of claim 4, wherein the coupling of the third portion of the sound from the second chamber is via at least a third aperture.

6. The method of claim 5, wherein the coupling of the third portion of the sound from the second chamber includes coupling the third portion of the sound outside of the media device via a plurality of apertures.

7. The method of claim 5 wherein the coupling of the third portion of the sound from the second chamber includes coupling the third portion of the sound from the second chamber to a third chamber associated with the media device, the third chamber including a plurality of apertures for coupling a forth portion of the sound outside of the media device.

8. The method of claim 1, wherein the acoustic source includes one of a transducer and a speaker.

9. The method of claim 1 comprising adjusting the volume of the first chamber in relation to the volume of the second chamber to tune the first portion of the sound.

10. The method of claim 3 comprising adjusting at least one of the area of the at least first aperture, the area of the at least second aperture, the volume of the first chamber, and the volume of the second chamber in relation to each other to tune the first portion of the sound.

11. The method of claim 3 comprising adjusting the area of the at least first aperture in relation to the area of the at least second aperture to tune the first portion of the sound.

12. The method of claim 5 comprising adjusting at least one of the area of the at least first aperture, the area of the at least second aperture, the area of the at least third aperture, the volume of the first chamber, and the volume of the second chamber in relation to each other to tune the first portion of the sound.

13. The method of claim 1, wherein the emitting including emitting the sound via at least a fifth aperture from the acoustic source into the first chamber.

14. The method of claim 3 comprising sealing at least one of the at least first aperture and the at least second aperture using a medium.

15. The method of claim 14, wherein the medium includes an acoustically permeable material.

16. The method of claim 15 comprising adjusting at least one of the acoustic permeability of the medium of the at least first aperture, the acoustic permeability of the medium of the at least second aperture, the area of the at least first aperture, the area of the at least second aperture, the volume of the first chamber, and the volume of the second chamber in relation to each other to tune the first portion of the sound.

17. The method of claim 14, wherein the medium includes a mesh.

18. The method of claim 1, wherein at least one of the first and second chambers includes substantially air.

19. The method of claim 1, wherein at least one of the first and second chambers includes at least one of a gas other than air, a gas mixture other than air, and acoustically conductive matter.

20. The method of claim 1, wherein the media device includes one of a wireless communications device, a personal digital assistant, a portable computer, a portable music player, a portable video player, and a portable multimedia device.

21. The method of claim 1, wherein the first and second chambers are included within a peripheral element of the media device.

22. The method of claim 21, wherein the peripheral element includes one of a headphone, wireless headphone, and a ear-coupling housing.

23. The method of claim 1, wherein a portion of the acoustic source is directly coupled to the second chamber.

24. A system for delivering sound from a media device comprising:
an acoustic source for emitting a sound,
a first chamber for receiving the sound and coupling a first portion of the sound outside of the media device, and
a second chamber for receiving a second portion of the sound from the first chamber.

25. The system of claim 24 comprising a first aperture for coupling the first portion of the sound from the first chamber to outside of the media device.

26. The system of claim 24 comprising a second aperture for coupling the second portion of the sound from the first chamber to the second chamber.

27. The system of claim 26 comprising a third aperture for coupling a third portion of the sound from the second chamber to outside of the second chamber.

28. The system of claim 27, wherein the coupling of the third portion of the sound from the second chamber includes coupling the third portion of the sound outside of the media device via a plurality of apertures.

29. The system of claim 27 wherein the coupling of the third portion of the sound from the second chamber includes coupling the third portion of the sound from the second chamber to a third chamber associated with the media device, the third chamber including a plurality of apertures for coupling a forth portion of the sound outside of the media device.

30. The system of claim 24, wherein the acoustic source includes one of a transducer and a speaker.

31. The system of claim 24 wherein the volume of the first chamber is configured in relation to the volume of the second chamber to tune the first portion of the sound.

32. The system of claim 26 wherein at least one of the area of the at least first aperture, the area of the at least second aperture, the volume of the first chamber, and the volume of the second chamber are configured in relation to each other to tune the first portion of the sound.

33. The system of claim 26 wherein the area of the at least first aperture is configured in relation to the area of the at least second aperture to tune the first portion of the sound.

34. The system of claim 27 wherein at least one of the area of the at least first aperture, the area of the at least second aperture, the area of the at least third aperture, the volume of the first chamber, and the volume of the second chamber are configured in relation to each other to tune the first portion of the sound.

35. The system of claim 24 comprising a fifth aperture for coupling the sound from the acoustic source into the first chamber.

36. The system of claim 26 comprising a medium for sealing at least one of the at least first aperture and the at least second aperture.

37. The system of claim 36, wherein the medium includes an acoustically permeable material.

38. The system of claim 37, wherein at least one of the acoustic permeability of the medium of the at least first aperture, the acoustic permeability of the medium of the at least second aperture, the area of the at least first aperture, the area of the at least second aperture, the volume of the first chamber, and the volume of the second chamber are configured in relation to each other to tune the first portion of the sound.

39. The system of claim 36, wherein the medium includes a mesh.

40. The system of claim 24, wherein at least one of the first and second chambers includes substantially air.

41. The system of claim 24, wherein at least one of the first and second chambers includes at least one of a gas other than air, a gas mixture other than air, and acoustically conductive matter.

42. The system of claim 24, wherein the media device includes one of a wireless communications device, a personal digital assistant, a portable computer, a portable music player, a portable video player, and a portable multimedia device.

43. The system of claim 24, wherein the first and second chambers are included within a peripheral element of the media device.

44. The system of claim 43, wherein the peripheral element includes one of a headphone, wireless headphone, and a ear-coupling housing.

45. The system of claim 24, wherein a portion of the acoustic source is directly coupled to the second chamber.

46. A portable wireless communications device comprising:
a housing,
a speaker within the housing for emitting a sound,
a first chamber within the housing for receiving the sound and coupling a first portion of the sound outside of the housing, and
a second chamber within the housing for receiving a second portion of the sound from the first chamber via at least one aperture between the first and second chamber.
